(19) United States
(12) Patent Application Publication
(10) Pub. No.: US 2025/0185872 A1
(43) Pub. Date: Jun. 12, 2025

(54) SELECTIVELY FIXABLE POLE MOP

(71) Applicant: Je Hoon KIM, Daegu (KR)

(72) Inventor: Je Hoon KIM, Daegu (KR)

(21) Appl. No.: 19/055,448

(22) Filed: Feb. 17, 2025

Related U.S. Application Data
(63) Continuation of application No. PCT/KR2022/012425, filed on Aug. 19, 2022.

(30) Foreign Application Priority Data
Aug. 18, 2022 (KR) 10-2022-0103596

(51) Int. Cl. A47L 13/256; A47L 13/02; A47L 13/12; A47L 13/38; B25G 3/38

(52) U.S. Cl. CPC A47L 13/256; A47L 13/02; A47L 13/12; A47L 13/38; B25G 3/38

(57) ABSTRACT

Provided is a selectively fixable pole mop comprising a base plate to which a cleaning fabric is attachable, wherein: the base plate is rotatable to enable a user to perform cleaning such as wiping by bringing the front surface or the rear surface of the base plate into close contact with a surface, and the rotating base plate is fixable by a fixing part to enable the user to perform, by the fixed base plate, combination cleaning such as sweeping or scraping a surface; and the selectively fixable pole mop comprising the base plate and a connection member includes a fixing part connected to the base plate or the connection member and configured to selectively fix the rotating base plate so that a user can restrict rotation of the base plate as necessary to use the pole mop for combination cleaning such as sweeping or scraping a surface.

### TECHNICAL FIELD

The present invention relates to a selectively fixable mop, and more specifically, to a selectively fixable mop comprising a base plate to which a cleaning fabric is attachable, wherein the base plate is rotatable to enable a user to perform cleaning such as wiping by bringing the front surface or the rear surface of the base plate into close contact with the floor surface, the wall surface, the ceiling, etc., and a fixing part fixes the rotating base plate to enable the user to perform cleaning such as sweeping or scraping the floor surface, the wall surface, the ceiling, etc. using the fixed base plate.

### BACKGROUND ART

In general, cleaning tools used for cleaning living spaces such as homes and offices are classified: into vacuum cleaners, which use suction power to remove dust and debris from the floor; steam cleaners, which heat a rag using steam to facilitate the removal of stubborn stains; and mops, which wipe the floor while pushing and pulling a rag or a cleaning fabric attached to the bottom surface thereof.

Meanwhile, the mop is a cleaning tool that allows a user to attach a rag or a cleaning fabric to the bottom of a mop body to perform wiping by pushing and pulling he mop with a handle. The rag or the cleaning fabric is attached to the bottom of the mop body to wipe the floor surfaces or the wall surfaces in various places.

Now, a conventional art will be examined.

Korean Utility Model Registration No. 20-0376049 discloses a mop with a detachable rag, which includes a handle with an upper grip, a rag support means coupled to the lower portion of the handle, and a cleaning fabric coupled to the rag support unit, comprising: a ‘ [symbol] ’-shaped supporter which includes a support plate having a coupling hole formed at the upper center and support brackets which extend downwards from both ends of the support plate and have rotary shaft protrusions formed at the lower portion of the inner surface of the extension end; a rag plate coupled to the inner sides of the support brackets of the supporter, and including Velcro strips on front and rear upper surfaces, a plurality of anti-slip protrusions provided on the upper portions of the front and rear surfaces, and insertion grooves provided at the centers of both sides for receiving the rotary shaft protrusions of the support brackets; and a cleaning fabric wrapping around the rag plate and detachably coupled to the Velcro strips on the front and rear surfaces of the rag plate.

The aforementioned conventional art primarily describes a structure in which the rag plate rotates around the supporter, allowing the both surfaces of the rag plate to be selectively in close contact with the floor during use.

However, since there is no component to restrict the rotation of the rag plate rotating around the supporter, it is difficult for a user to fix the rag plate to sweep or scrape the floor surface to be cleaned, making it necessary to have a separate broom for sweeping or scraping the floor surface.

### DISCLOSURE

### Technical Problem

Accordingly, the present invention has been made in view of the above-mentioned problems occurring in the related art, and it is an object of the present invention to provide a selectively fixable mop, which includes a base plate and a connection member, wherein a fixing part is configured to selectively fix the rotating base plate to restrict the rotation of the base plate as needed, thereby allowing a user to use the mop for sweeping or scraping the floor surface, the wall surface, the ceiling, and so on.

### Technical Solution

To accomplish the above-mentioned objects, according to the present invention, there is provided a selectively fixable mop including: a base plate configured to sweep, gather, or scrape various substances and objects on the surface to be cleaned; and a connection member connected to the base plate to allow the base plate to rotate, and having a handle provided on one side for user grip, wherein the mop further comprises a fixing part that is connected to either the base plate or the connection member and is designed to selectively fix the rotating base plate.

### Advantageous Effect

According to embodiments of the present invention, the selectively fixable mop can retain the fundamental purpose of allowing the cleaning fabric to be attached to the base plate for cleaning indoor and outdoor spaces, when it is necessary to sweep or scrape the surface to be cleaned while the user performs mopping by bringing the front surface or the rear surface of the base plate into close contact with the floor surface, the wall surface, the ceiling, and so on, can restrict the rotation of the base plate using the fixing part, enabling the mop to function as a brush, and allow the user to conveniently switch between mopping and brushing without requiring a separate broom, providing user convenience.

### DESCRIPTION OF DRAWINGS

FIG. 1 is a front view of a selectively fixable mop according to a first embodiment of the present invention.

FIG. 2 is a side-sectional view of the selectively fixable mop according to the first embodiment of the present invention.

FIG. 3 is a used state diagram (side view) of the selectively fixable mop according to the first embodiment of the present invention.

FIG. 4 is a used state diagram (front view) of the selectively fixable mop according to the first embodiment of the present invention.

FIG. 5 is a used state diagram (plan view) along the line (A-A′) of FIG. 4.

FIG. 6 is a used state diagram (front view) of a groove part of the selectively fixable mop according to the first embodiment of the present invention.

FIG. 7 is a used state diagram (plan view) along the line (B-B′) of FIG. 6.

FIG. 8 is a used state diagram (front view) of a selectively fixable mop according to a second embodiment of the present invention.

FIG. 9 is a used state diagram (plan view) along the line (C-C′) of FIG. 6.

FIG. 10 is a used state diagram (front view) of a selectively fixable mop according to a third embodiment of the present invention.

FIG. 11 is a used state diagram (front view) of a selectively fixable mop according to a fourth embodiment of the present invention.

FIG. 12 is a used state diagram (front view) of a selectively fixable mop according to a fifth embodiment of the present invention.

FIG. 13 is a used state diagram (front view) of a selectively fixable mop according to a sixth embodiment of the present invention.

100: Base plate

100: Cut part

200: Connection member

210: Rotary shaft

220: Extension part

223: Groove part

300: Handle

400: Fixing part

410a: Fixing member

410b: Fixing member 420b: Insertion part

410c: Fixing member 420c: Insertion part

410d: Fixing member 420d: Insertion groove

410e: Fixing member 420e; Penetration part

430: Auxiliary fixing member

440: Finishing part

450: Auxiliary groove part

460: Fixing groove part

### Mode for Invention

The present invention relates to a selectively fixable mop, and more specifically, to a selectively fixable mop comprising a base plate to which a cleaning fabric is attachable, wherein the base plate is rotatable to enable a user to perform cleaning such as wiping by bringing the front surface or the rear surface of the base plate into close contact with the floor surface, the wall surface, the ceiling, etc., and a fixing part fixes the rotating base plate to enable the user to perform cleaning such as sweeping or scraping the floor surface, the wall surface, the ceiling, etc. using the fixed base plate.

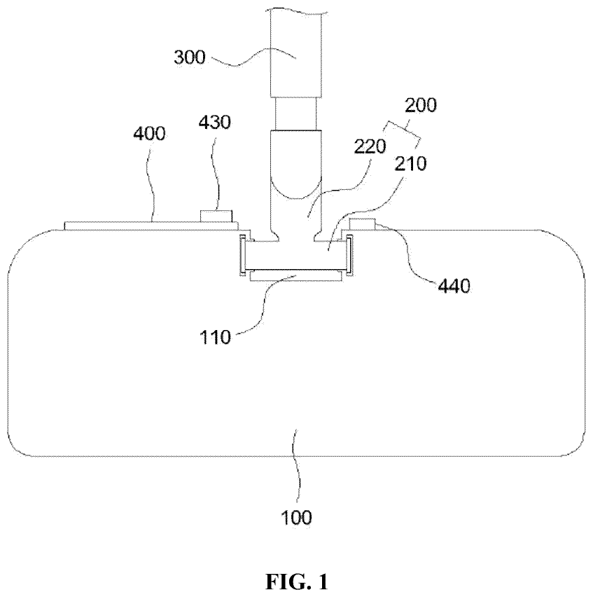

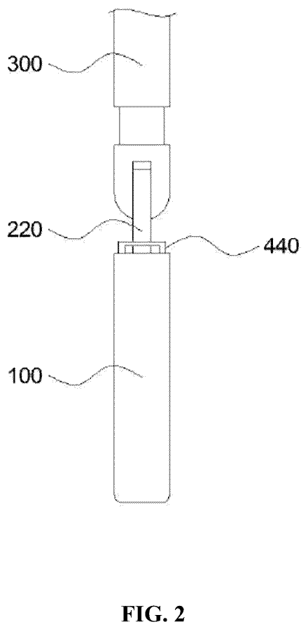

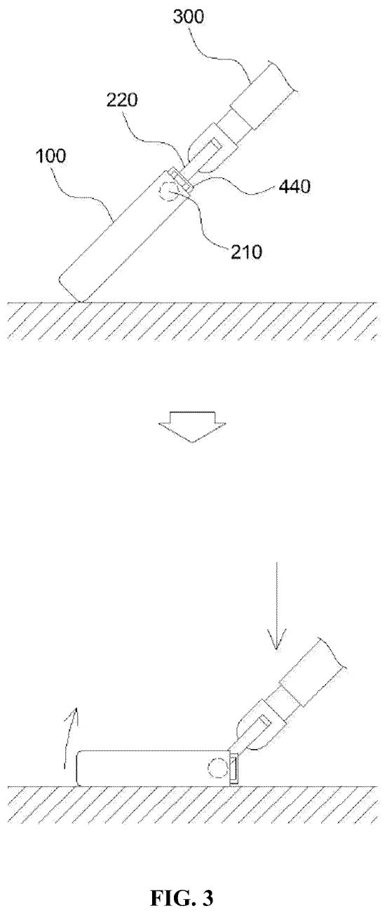

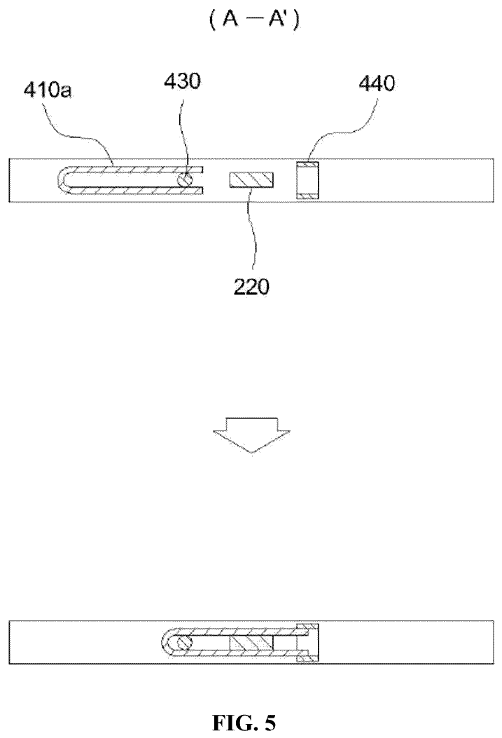

Hereinafter, the preferred configuration and operation of the present invention to achieve the aforementioned objective will be described below with reference to FIGS. 1 to 13 of the accompanying drawings.

The structure of the present invention will be examined with reference to FIGS. 1 to 5. A selectively fixable mop according to a first embodiment of the present invention includes: a base plate 100 configured to sweep, gather, or scrape various substances and objects on the surface to be cleaned; and a connection member 200 connected to the base plate 100 to allow the base plate 100 to rotate, and having a handle 300 provided on one side for user grip, wherein the mop further includes a fixing part 400 that is connected to either the base plate 100 or the connection member 200 and is designed to selectively fix the rotating base plate 100.

The present invention having the above configuration will be described in more detail.

First, a conventional mop generally includes a base plate 100, a connection member 200, and a handle 300.

The base plate 100 is formed in a plate shape, and is configured to allow a cleaning fabric to be selectively attached and detached on one side.

Additionally, the base plate 100 is pivotally coupled to a rotary shaft 210 of the connection member 200 to be rotatable around the shaft.

Here, the cleaning fabric may include various types of rags, cloths, dishcloths, and cleaning pads that absorb water for wiping floors, walls, and ceilings. The attachment and detachment structure of the cleaning fabric to the base plate 100 may employ various conventional attachment and detachment methods, such as groove insertion structures or Velcro structures.

As described above, the mop according to the present invention is configured as follows.

The mop includes the fixing part 400 that is connected to either the base plate 100 or the connection member 200 to selectively fix the rotating base plate 100.

That is, the fixing part 400 is configured to selectively fix the rotating base plate 100, which rotates by being connected to the connection member 200, allowing the user to fix the base plate 100 as needed for brushing purposes, such as sweeping or scraping the cleaning surface.

Furthermore, the fixing part 400 is configured to fix the base plate 100 by restricting the rotation of the base plate 100 when the base plate 100 maintains parallel with the handle 300.

That is, when the base plate 100 maintains parallel with the handle 300, the fixing part 400 fixes the base plate 100, enabling the bottom surface of the base plate 100 to more effective sweep or scrap the cleaning surface.

Meanwhile, the base plate 100 includes a cut portion 110 formed at the upper central portion thereof to penetrate from the front to the rear of the base plate 100. The connection member 200 includes: a rotary shaft 210 of which both ends are pivotally coupled to both ends of the inside of the cut portion 110; and an extension part 220 which extends upward from the central portion of the rotary shaft 210 and includes a handle 300 provided at one end of the upper portion thereof.

Hereinafter, various embodiments of the present invention, configured as described above, will be described.

### First Embodiment

As illustrated in FIGS. 1, 2, and 3, the fixing part 400 is configured on one side of the base plate 100 to be moved and fixed to the front or rear part of the extension part 220, moves the fixing part 400 to the front or rear side of the extension part 220 when the base plate 100 maintains parallel with the handle 300 to be positioned on the front or rear sides of the extension part 220, thereby restricting the rotation of the base plate 100 and fixing the base plate 100.

That is, when the fixing part 400 is positioned on one side of the base plate 100 while maintaining a gap from the front or rear side of the extension part 220, the base plate 100 remains in a rotatable state. So, the user can press the front or rear of the base plate 100 against the floor for the mopping purpose. However, when the fixing part 400 is moved so that one end and the other end of the fixing part 400 are respectively positioned on the front or rear side of the extension part 220, even though a predetermined power is applied to the base plate 100, the one end and the other end of the fixing part 400 is retained to the front or rear side of the extension part 220 to be restricted in rotation of the base, restricting the rotation of the base plate 100, thus allowing the user to use the base plate 100 for brushing purpose.

Meanwhile, the fixing part 400 includes: a fixing member 410a, which is formed on one side of the base plate 100 and is selectively slid or pressed to move to the front or rear side of the extension part 220; and an auxiliary fixing member 430, which is configured to selectively fix the fixing member 410a moving to the front or rear side of the extension part 220.

Here, it is preferable that the fixing member 410a is formed in such a way that, when the fixing member 410a is moved to the front or rear side of the extension part 220, one end and the other end of the fixing member 410a are respectively positioned on the front and rear sides of the extension part 220. Additionally, it is preferable that the auxiliary fixing member 430 is configured to selectively restrict the movement of the fixing member 410a. This ensures that when the fixing member 410a is either positioned at one side of the base plate 100 at an interval from the extension part 220 or one end and the other end of the fixing member 410a are respectively positioned on the front and rear sides of the extension part 220, the auxiliary fixing member 430 serves to firmly fix the fixing member 410a, preventing unintended movement of the fixing member 410a due to external factors.

In addition, one of various conventional structures that restrict the movement of the fixing member 410a to selectively fix the fixing member 410a may be applied to the auxiliary fixing member 430. In the present invention, the auxiliary fixing member 430 is configured to be movable up and down on one side of the upper portion of the base plate 100 having the fixing member 410a, such that the auxiliary fixing member 430 can fix the fixing member 410a by pressing the upper portion of the fixing member 410a when moving downward.

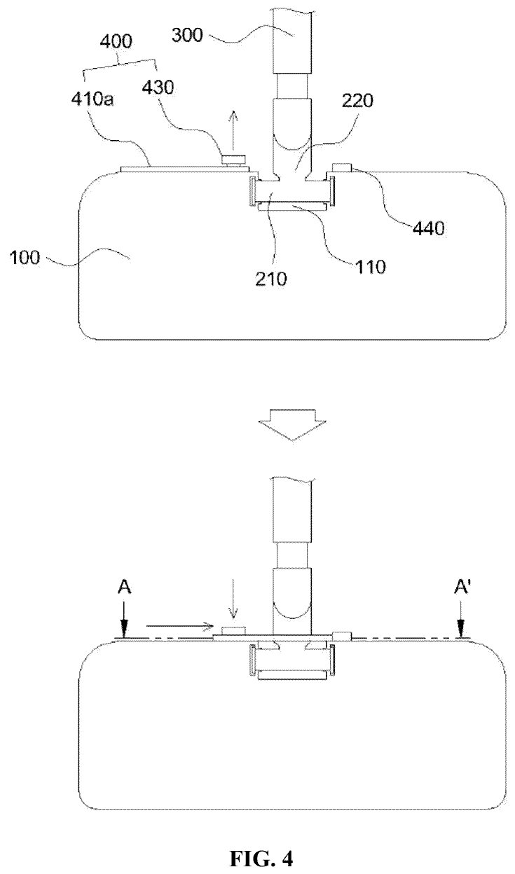

In other words, as illustrated in FIG. 4, the auxiliary fixing member 430 which fixes the fixing member 410a formed at one side of the upper portion of the base plate 100 is moved upward to position one end and the other end of the fixing member 410a on the front and rear sides of the extension part 220. After the one end and the other end of the fixing member 410a are positioned on the front and rear sides of the extension part 220, the auxiliary fixing member 430 is moved downward to firmly fix the fixing member 410a.

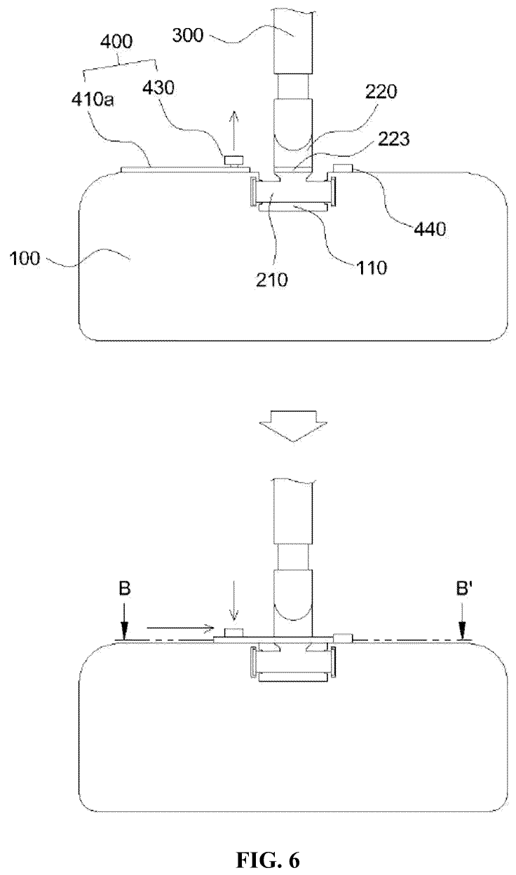

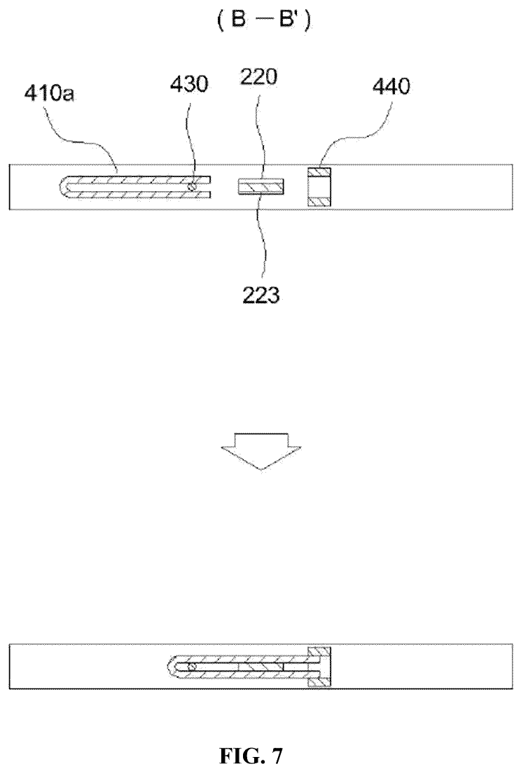

Additionally, as illustrated in FIGS. 6 and 7, grooves 223 are formed at the front and rear sides of the extension part 220 so that the one end and the other end of the fixing member 410a positioned on the front and rear sides of the extension part 220 are inserted thereinto.

Moreover, as illustrated in FIGS. 1 to 7, a finishing part 440, into which the one end and the other end of the fixing member 410a are respectively inserted when the one end and the other end of the fixing member 410a are positioned on the front and rear sides of the extension part 220 while the fixing member 410a moves, is configured on the opposite side of the base plate 100.

### Second Embodiment

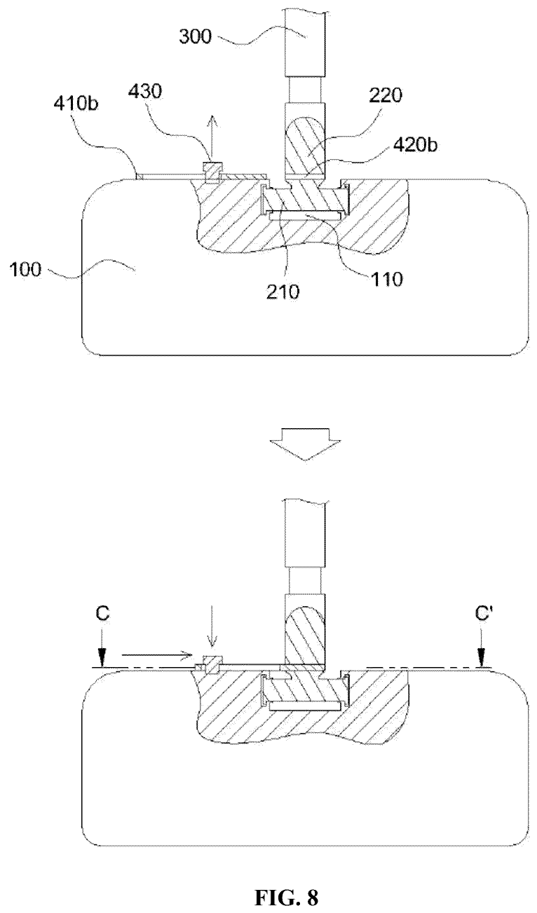

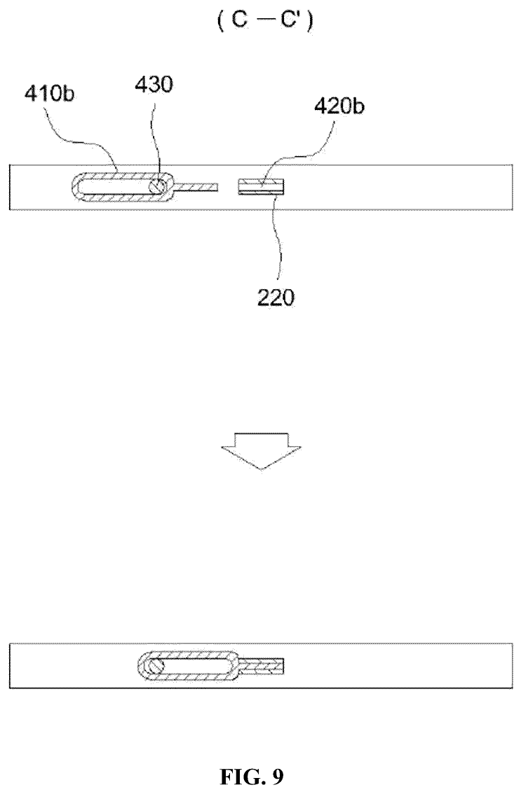

As illustrated in FIGS. 8 and 9, the fixing part 400 includes: a fixing member 410b, which is formed on one side of the base plate 100 and is selectively slid or pressed to be inserted into an insertion part 420b of the extension part 220; and the insertion part 420b, which is formed on one side of the extension part 220 such that one end of the fixing member 410b can be inserted thereinto when the base plate 100 maintains parallel with the handle 300.

Here, the insertion part 420b may be inserted into or formed in one side of the extension part 220 or formed to penetrate the extension part 220 from one side to the other side.

That is, when the user moves the fixing member 410b to insert one end of the fixing member 410b into the insertion part 420b, the rotation of the base plate 100 can be easily restricted. As a result, the base plate 100, once fixed by the fixing member 410b, can be utilized for brushing or similar purposes.

### Third Embodiment

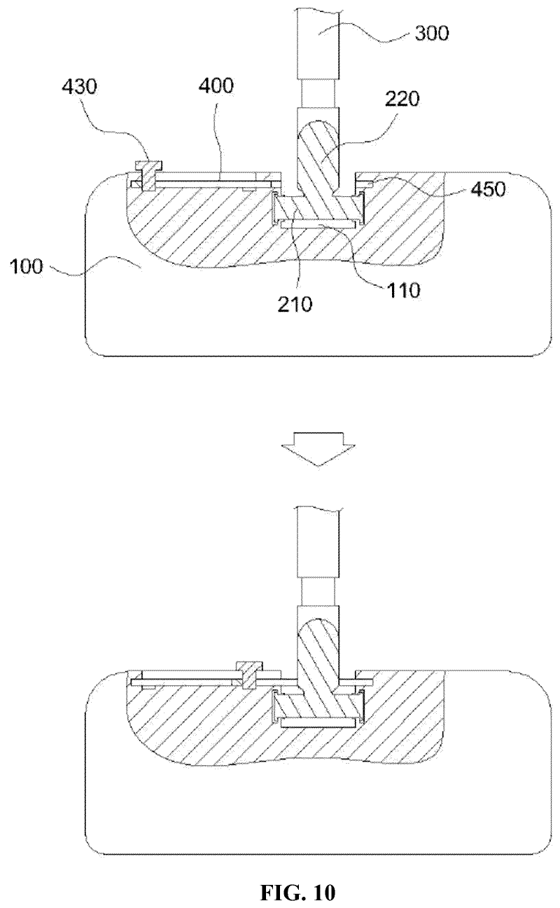

As illustrated in FIG. 10, the fixing part 400 is configured in such a way that one side is inserted into the base plate 100 and is designed to be moved to the front and rear sides of the extension part 220 and fixed at the front and rear sides of the extension part 220, wherein when the base plate 100 maintains parallel with the handle 300, the one side of the fixing part 400 is moved to the front and rear sides of the extension part 220 to be positioned at one of the front and rear sides of the extension part 220, thus fixing the base plate 100 by restricting the rotation of the base plate 100.

Preferably, the fixing part 400 is configured in such a way that one side is inserted into the base plate 100 to be movable toward the extension part 220. Additionally, an auxiliary fixing member 430 may be connected to one side of the fixing part 400 inserted into the base plate 100, allowing the user to manipulate the auxiliary fixing member 430 to move or fix the fixing part 400.

That is, when the fixing part 400 is moved so that one end and the other end of the fixing part 400 are positioned on the front and rear sides of the extension part 220, the rotation of the base plate 100 is restricted by the one side and the other side of the fixing part 400 retained to the front and rear sides of the extension part 220, thereby enabling the base plate 100 to be used for brushing or similar applications.

### Fourth Embodiment

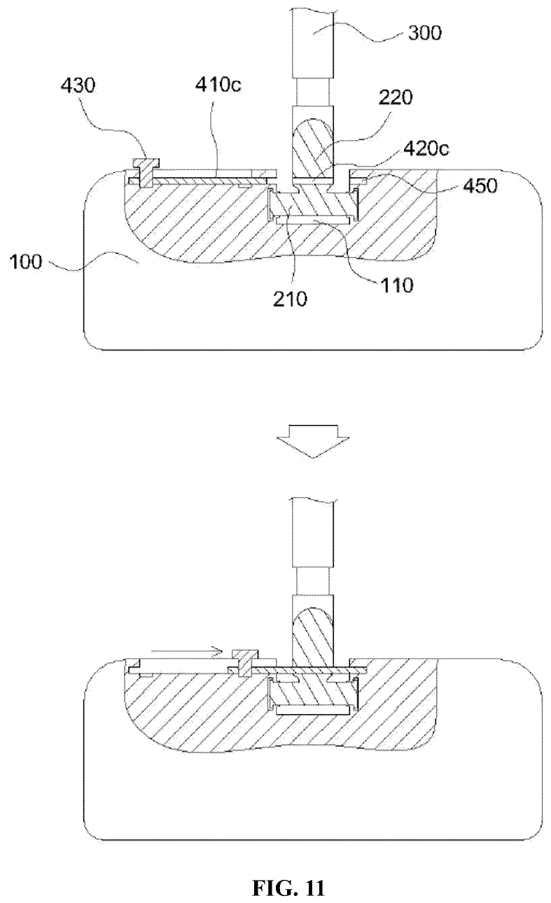

As illustrated in FIG. 11, the fixing part 400 includes: a fixing member 410c, of which one end is inserted into the base plate 100 and which is selectively slid or pressed to be inserted into an insertion part 420c of the extension part 220; and the insertion part 420c, which is formed on one side of the extension part 220 to allow the insertion of one end of the fixing member 410c depending on the manipulation of the fixing member 410c when the base plate 100 maintains parallel with the handle 300.

Here, the insertion part 420c may be inserted into one side of the extension part 220 or penetrates the extension part 220 from one side to the other.

In addition, when the insertion part 420c is formed to penetrate the extension part 220 from one side to the other, an auxiliary groove 450 is formed on the inner side of the base plate 100 adjacent to the opposite side of the extension part 220, allowing the end of the fixing member 410c inserted through the insertion part 420c to be inserted and securely fixed.

That is, when the user moves the fixing member 410c downward to insert one end of the fixing member 410c into the insertion part 420c, the rotation of the base plate 100 can be easily restricted. As a result, the base plate 100, which is fixed by the fixing member 410c and restricted in movement, can be utilized for brushing or similar purposes.

### Fifth Embodiment

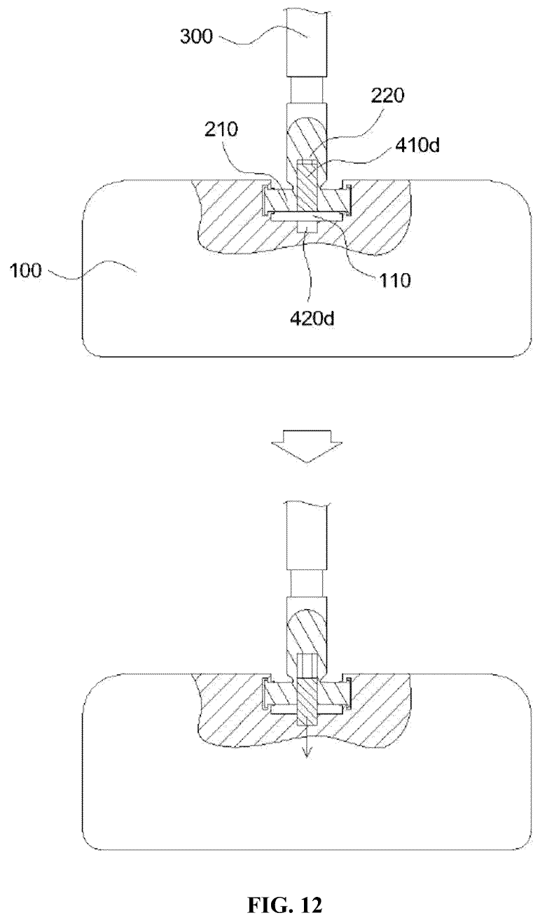

As illustrated in FIG. 12, the fixing part 400 includes: a fixing member 410d, which is formed at one side of the connection member 200 to be moved up and down; and an insertion groove 420d, which is formed on one side of the upper portion of the base plate 100 having the cut part 110 to allow the insertion of one end of the fixing member 410d depending on the manipulation of the fixing member 410d when the base plate 100 maintains parallel with the handle 300.

That is, when the user moves the fixing member 410d downward to insert one end of the fixing member 410d into the insertion groove 420d, the rotation of the base plate 100 can be easily restricted. As a result, the base plate 100, which is fixed by the fixing member 410d and restricted in movement, can be utilized for brushing or similar purposes.

### Sixth Embodiment

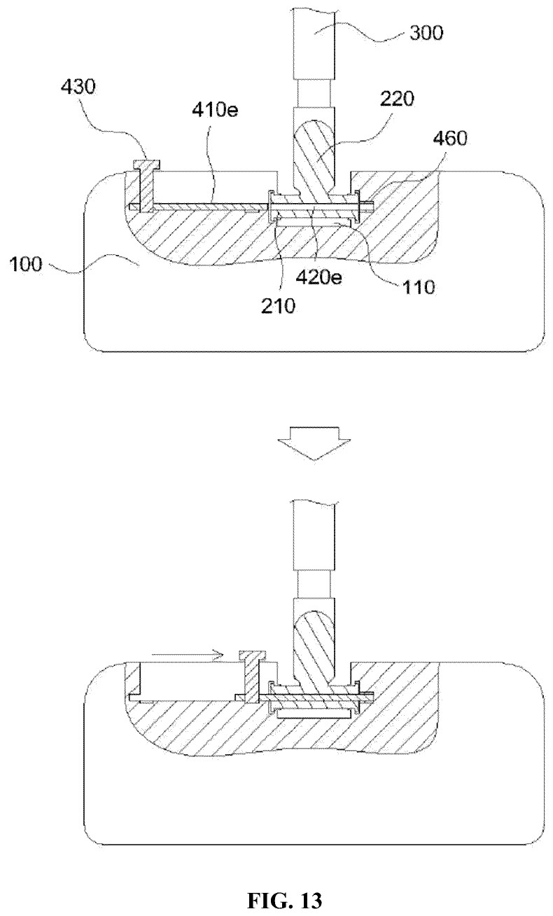

As illustrated in FIG. 13, the fixing part 400 includes: a fixing member 410e, of which one end is inserted into the base plate 100 and which is selectively slid or pressed to be inserted into a through-hole part 420e of the rotary shaft 210; the through-hole part 420e which is formed on one side of the rotary shaft 210 to penetrate in the length direction of the rotary shaft 210, allowing the insertion of one end of the fixing member 410e depending on the manipulation of the fixing member 410e when the base plate 100 maintains parallel with the handle 300; and a fixing groove part 460, which is configured inside the base plate 100 and configured to allow the insertion and fixation of the end of the fixing member 410e, which is inserted into the through-hole part 420e and penetrates through the rotary shaft 210.

That is, when the fixing member 410e is moved, one end of the fixing member 410e is inserted into one side of the through-hole part 420e and the distal end of the fixing member 410e is fixed by the fixing groove part 460 to restrict the rotation of the base plate 100, allowing the base plate 100 restricted in rotation to be used for brushing or similar applications.

According to embodiments of the present invention, the selectively fixable mop can retain the fundamental purpose of allowing the cleaning fabric to be attached to the base plate for cleaning indoor and outdoor spaces, when it is necessary to sweep or scrape the surface to be cleaned while the user performs mopping by bringing the front surface or the rear surface of the base plate into close contact with the floor surface, the wall surface, the ceiling, and so on, can restrict the rotation of the base plate using the fixing part, enabling the mop to function as a brush, and allow the user to conveniently switch between mopping and brushing without requiring a separate broom. providing user convenience.

1. A selectively fixable mop comprising:
a base plate (100) configured to sweep, gather, or scrape various substances and objects on the surface to be cleaned; and
a connection member (200) connected to the base plate (100) to allow the base plate (100) to rotate, and having a handle (300) provided on one side for user grip,
wherein the mop further comprises a fixing part (400) that is connected to either the base plate (100) or the connection member (200) and is designed to selectively fix the rotating base plate (100).

2. The selectively fixable mop according to claim 1, wherein the fixing part (400) is configured to fix the base plate (100) by restricting the rotation of the base plate (100) when the base plate (100) maintains parallel with the handle (300).

3. The selectively fixable mop according to claim 1, wherein the base plate (100) includes a cut portion (110) formed at the upper central portion thereof to penetrate the base plate (100) from the front to the rear, and
wherein the connection member (200) includes: a rotary shaft (210) of which both ends are pivotally coupled to both ends of the inside of the cut portion (110); and an extension part (220) which extends upward from the central portion of the rotary shaft (210) and includes a handle (300) provided at one end of the upper portion thereof.

4. The selectively fixable mop according to claim 3, wherein the fixing part (400) is configured on one side of the base plate (100) to be moved and fixed to the front or rear part of the extension part (220), and
wherein the fixing part (400) is moved to the front or rear side of the extension part (220) when the base plate (100) maintains parallel with the handle (300) to be positioned on the front or rear sides of the extension part (220), restricting the rotation of the base plate (100) and fixing the base plate (100).

5. The selectively fixable mop according to claim 4, wherein the fixing part (400) includes:
a fixing member (410a), which is formed on one side of the base plate (100) and is selectively slid or pressed to move to the front or rear side of the extension part (220); and
an auxiliary fixing member (430), which is configured to selectively fix the fixing member (410a) moving to the front or rear side of the extension part (220).

6. The selectively fixable mop according to claim 3, wherein the fixing part (400) includes: a fixing member (410b), which is formed on one side of the base plate (100) and is selectively slid or pressed to be inserted into an insertion part (420b) of the extension part (220); and the insertion part (420b), which is formed on one side of the extension part (220) such that one end of the fixing member (410b) can be inserted thereinto when the base plate (100) maintains parallel with the handle (300).

7. The selectively fixable mop according to claim 3, wherein the fixing part (400) is configured in such a way that one side is inserted into the base plate (100) and is designed to be moved to the front and rear sides of the extension part (220) and fixed at the front and rear sides of the extension part (220), and
wherein when the base plate (100) maintains parallel with the handle (300), the one side of the fixing part (400) is moved to the front and rear sides of the extension part (220) to be positioned at one of the front and rear sides of the extension part (220), thus fixing the base plate (100) by restricting the rotation of the base plate (100).

8. The selectively fixable mop according to claim 3, wherein the fixing part (400) includes:
a fixing member (410c), of which one end is inserted into the base plate (100) and which is selectively slid or pressed to be inserted into an insertion part (420c) of the extension part (220); and
the insertion part (420c), which is formed on one side of the extension part (220) to allow the insertion of one end of the fixing member (410c) depending on the manipulation of the fixing member (410c) when the base plate (100) maintains parallel with the handle (300).

9. The selectively fixable mop according to claim 3, wherein the fixing part (400) includes:
a fixing member (410d), which is formed at one side of the connection member (200) to be moved up and down; and
an insertion groove (420d), which is formed on one side of the upper portion of the base plate (100) having the cut part (110), allowing the insertion of one end of the fixing member (410d) depending on the manipulation of the fixing member (410d) when the base plate (100) maintains parallel with the handle (300).

10. The selectively fixable mop according to claim 3, wherein the fixing part (400) includes:
a fixing member (410e), of which one end is inserted into the base plate (100) and which is selectively slid or pressed to be inserted into a through-hole part (420e) of the rotary shaft (210);
the through-hole part (420e) which is formed on one side of the rotary shaft (210) to penetrate in the length direction of the rotary shaft (210), allowing the insertion of one end of the fixing member (410e) depending on the manipulation of the fixing member (410e) when the base plate (100) maintains parallel with the handle (300); and
a fixing groove part (460), which is configured inside the base plate (100) and configured to allow the insertion and fixation of the end of the fixing member (410e), which is inserted into the through-hole part (420e) and penetrates through the rotary shaft (210).
